(19) United States
(12) Patent Application Publication
(10) Pub. No.: US 2017/0174090 A1
(43) Pub. Date: Jun. 22, 2017

(54) SMART UTILITY TOWER

(71) Applicant: Totem Power, Inc., Bedford Hills, NY (US)

(72) Inventors: Brian David LAKAMP, Bedford, NY (US); Robert Frank MARANO, Bedford, NY (US)

(21) Appl. No.: 15/381,460

(22) Filed: Dec. 16, 2016

Related U.S. Application Data
(60) Provisional application No. 62/269,623, filed on Dec. 18, 2015.

(51) Int. Cl. B60L 11/18; H02J 7/00; H02J 7/02; H02J 3/38

(52) U.S. Cl. CPC B60L 11/1816; H02J 3/383; H02J 7/0052; H02J 7/025; H02J 2007/0062; B60L 2200/10

(57) ABSTRACT

Systems and methods for energy generation, management and distribution via a utility tower are provided. The utility tower can include a vertical structure, at least one energy storage, at least one communication network to communicate power requirements, power quality, power available or any combination thereof, at least one power source coupled to the at least one energy storage, at least one controller to calculate at least one power distribution criterion and to control the energy transfer from the at least one energy storage to one or more loads based on the at least one power distribution criterion.

### CROSS REFERENCE TO RELATED APPLICATIONS

This application claims benefit of and priority to U.S. provisional application No. 62/269,623, filed on Dec. 18, 2015, all of which are incorporated herein by reference in their entirety.

### FIELD OF THE INVENTION

The invention relates generally to distributed power generation and energy distribution systems. More particularly, the invention relates to utility poles that can generate/provide clean and grid power to a variety of loads.

### BACKGROUND OF THE INVENTION

Currently, power generation and/or distribution systems can provide power to participating parties (e.g., houses and/or buildings). The power is typically generated at a large, centralized power plant, typically using power generation technology (e.g., coal, oil and/or nuclear) that can rely on a diminishing natural resource and/or can release unwanted emissions into the air and pollute the environment.

The associated networks typically provide power via a grid of interconnected electric power distribution lines typically through networks of connected buried and above ground power lines. The above ground power lines are typically housed on vertical poles. These poles typically include power lines that can pass from pole to pole, and can extend into structures of participating parties to provide power. One difficulty with current power lines can be that they can be dependent upon the integrity of the physical structure of the line to provide power. For example, during a storm power lines can break, causing one or more power line poles to fail to provide power. Another difficulty with power line poles and/or power lines is that they can be aesthetically unpleasing.

Other difficulties with current power lines can include: (a) a lack of effective and/or real-time monitoring, for example, an inability to know the exact power lines that failed and/or on which power line pole the failure occurred, (b) a lack of effective and/or real-time security, for example, whether power is siphoned off and if so, at the physical location of the siphoning, (c) current power lines can be passive and have an inability to supply their own sources of energy for the power demanded, and/or (d) an inability for current poles to store energy for emergency needs.

Structures that receive power from the power lines typically include power outlets which can allow electrical devices to receive power from the buildings. For example, for electric vehicles, users typically plug the vehicle into a power outlet similar to a power outlet used to power televisions and/or dishwashers. In some cities, electronic vehicle charging stations have been deployed at select locations (e.g., by some grocery stores), however, these vehicle charging stations can be limited in number and/or are typically not a relied upon source for charging an electric vehicle.

Other types of power generation can include power generated from renewable energy sources (e.g., wind and/or solar). For these renewable energy sources, energy captured in excess to what the grid can handle can be wasted and/or lost, due to, for example lack of a mechanism to store that excess energy. Current renewable energy sources typically include an intermittent ability to provide power, due to, for example, the sun only being out during the day, or wind only being available based on the weather.

Currently users typically charge their electric devices at home and/or work. Users may want to power portable electronic devices when outside of their homes and/or work. Smart phone users, laptop users, and other portable electronic users typically carry a portable charger and/or a power outlet based battery charger so that they can recharge their devices on the go. One difficulty with current device charging is that if users forget to bring their chargers, charging on the go can be impossible. Thus, many users run out of power on their portable electric devices before they have a chance to recharge.

Other devices that may need to be charged on the go can include unmanned vehicles (e.g., drones). Current unmanned vehicles can be limited by their battery life (e.g., approximately 30 minutes of flight time for drones), as most unmanned vehicles operate on a battery. While it can be desirable to have a higher capacity battery in an unmanned vehicle to boost the battery life, a bigger battery can add undesirable weight to the unmanned vehicle, thus powering an unmanned vehicle with larger batteries can be difficult.

Current unmanned vehicles carry other battery powered devices (e.g., medical equipment, video cameras, emergency equipment, communications equipment, flashlights and/or other devices as is known in the art). These devices can have their own batteries or draw power from the unmanned vehicle's battery. In the scenario where the devices have their own batteries, the life of the devices can depend on its corresponding battery's life.

Therefore, it can be desirable to provide charging capabilities that allow users to charge devices outside of their home, charge electric vehicles and/or provide a battery charging option for unmanned vehicles along their flight paths. It can also be desirable to provide power even when power lines are down and/or to provide clean power distribution. It can also be desirable to provide power via structures that are aesthetically pleasing. It can also be desirable to allow for power monitoring of power line poles (e.g., in real-time). It can also be desirable to allow for security monitoring of power line poles (e.g., in real-time). It can also be desirable to allow for power line poles that can supply their own sources of energy. It can also be desirable for power line poles to store energy for emergency needs. It can also be desirable for power line poles that can provide power to multiple load types.

It can also be desirable to provide storage for renewable energy sources to, for example, account for intermittent availability of the sources that generate the power (e.g., the sun) and/or provide a mechanism to avoid wasting power.

### SUMMARY OF THE INVENTION

Some advantage of the invention can include allowing one structure to provide multi-functional power generation, storage and/or distribution capabilities to structures, electric vehicles, drones, mobile telecommunications equipment, emergency response equipment, and other portable electric devices. Another advantage is that it can allow prioritized provisioning of power to various loads. Another advantage of the invention is that it can allow for grid balancing between prioritized loads to, for example, optimize operating constraints.

Another advantage of the invention can include reducing a dependency on grid power sources, for example, during peak usage time of loads. Another advantage of the invention can include optimizing cost of power and/or environmental protections. Another advantage of the invention can include optimizing quality of the power source, for example, voltage and/or frequency ranges. Another advantage of the invention can include for full usage all renewable energy from renewable energy sources.

Another advantage of the invention can include an ability to monitor power, viability, and/or security of a utility tower. Another advantage of the invention can include an ability to provide power to multiple load types.

In one aspect, the invention includes a utility tower for energy generation, management and distribution. The utility tower includes a vertical structure including at least one energy storage, and at least one communication network to communicate power requirements, power quality, power available or any combination thereof. The utility tower also includes at least one power source coupled to the at least one energy storage, and at least one controller to calculate at least one power distribution criterion and to control the energy transfer from the at least one energy storage to one or more loads based on the at least one power distribution criterion.

In some embodiments, the at least one power source is a renewable energy source or an electric grid. In some embodiments, the vertical structure further comprises a canopy. In some embodiments, the canopy comprises at least one renewable energy source that converts to electricity. In some embodiments, the converted electricity is supplied to the at least one energy storage.

In some embodiments, the at least one renewable energy source is a photovoltaic cell array having at least one photovoltaic cell. In some embodiments, the at least one communication network is a wired or wireless network.

In some embodiments, the utility tower includes at least one light coupled to the vertical structure. In some embodiments, the utility tower includes at least one charging port coupled to the vertical structure to allow a device to receive energy from the energy storage, an electric grid or both. In some embodiments, the utility tower includes at least one GPS sensor.

In some embodiments, the at least one energy storage is a rechargeable battery. In some embodiments, the utility tower includes an unmanned aerial vehicle docking station coupled to the canopy such that an unmanned aerial vehicle can land upon the canopy. In some embodiments, the utility tower includes a wireless inductive charger coupled to the unmanned aerial vehicle docking station to charge the unmanned aerial vehicle.

In some embodiments, the canopy is oriented at an angle with respect to the vertical structure to maximize the at least one solar cell's receipt of solar radiation. In some embodiments, the at least one charging port is an electric vehicle (EV) charging port and the vertical structure further comprises an EV cord management system. In some embodiments, the at least one charging port is a wireless inductive charger or a wired Universal Serial Bus (USB) connection. In some embodiments, the utility tower includes at least one router or WiFi hub coupled to the canopy.

In another aspect, the invention involves a method for energy generation, management and distribution for a utility tower comprising having a plurality of energy sources and a plurality of loads. The method involves receiving a load priority that indicates a priority for distributing power to the plurality of loads coupled to the utility tower, wherein the plurality of loads comprises at least two of a device coupled to a charging port of the utility tower, an energy storage of the utility tower, a light, and a controller. The method also involves determining, for each load coupled to the utility tower, a percentage of power of each energy source of the plurality of energy sources coupled to the utility tower to provide to a respective load based on the load priority. The method also involves providing the percentage of power from each energy source to each respective load.

In some embodiments, the plurality of energy sources comprises the energy storage of the utility tower, a renewable energy source coupled to the utility tower, an electric grid coupled to the utility tower, or any combination thereof.

In some embodiments, determining a percentage of power is further based on a first amount of power available from the renewable energy source, a second amount of power available from the energy storage, a third amount of power available from an electric grid coupled to the utility tower, time of day, historical time of day usage, a cost of power, weather conditions, regulatory statutes, emergency service reserved power or any combination thereof.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1A is a cross-sectional diagram of a utility tower, according to an illustrative embodiment of the invention;

FIG. 1B is a block diagram illustrating communication between components of the utility tower of FIG. 1A, according to an illustrative embodiment of the invention.

FIGS. 2A-2E are diagrams of various utility towers with canopies having various portions in various configurations, according to an illustrative embodiments of the invention;

FIG. 3 is a flow chart of a method for energy generation, management and/or distribution for a utility tower having a plurality of energy sources and a plurality of loads, according to an illustrative embodiment of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element. Further, where considered appropriate, reference numerals can be repeated among the figures to indicate corresponding or analogous elements.

### DETAILED DESCRIPTION

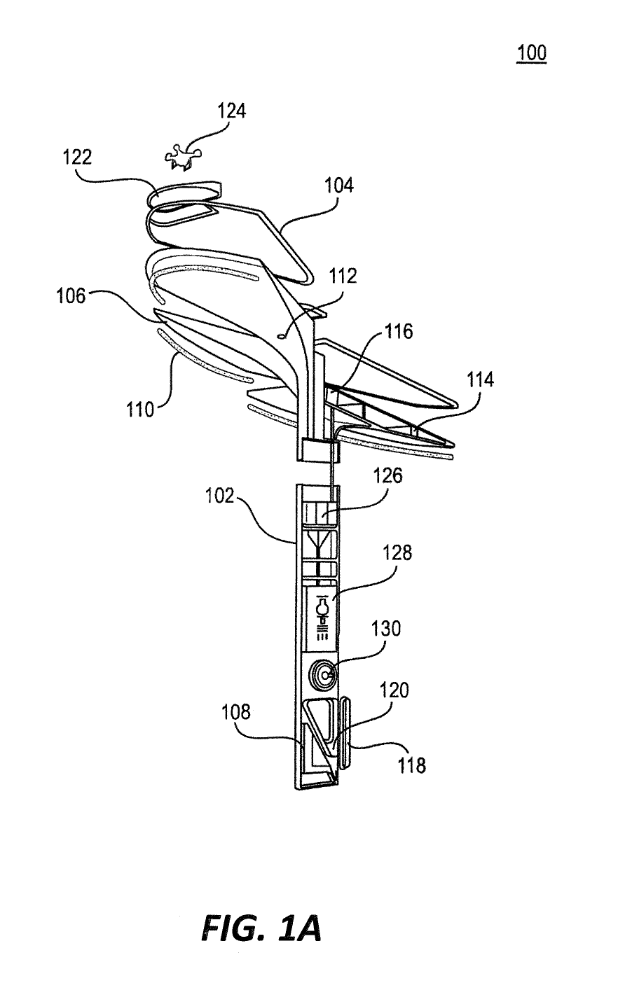

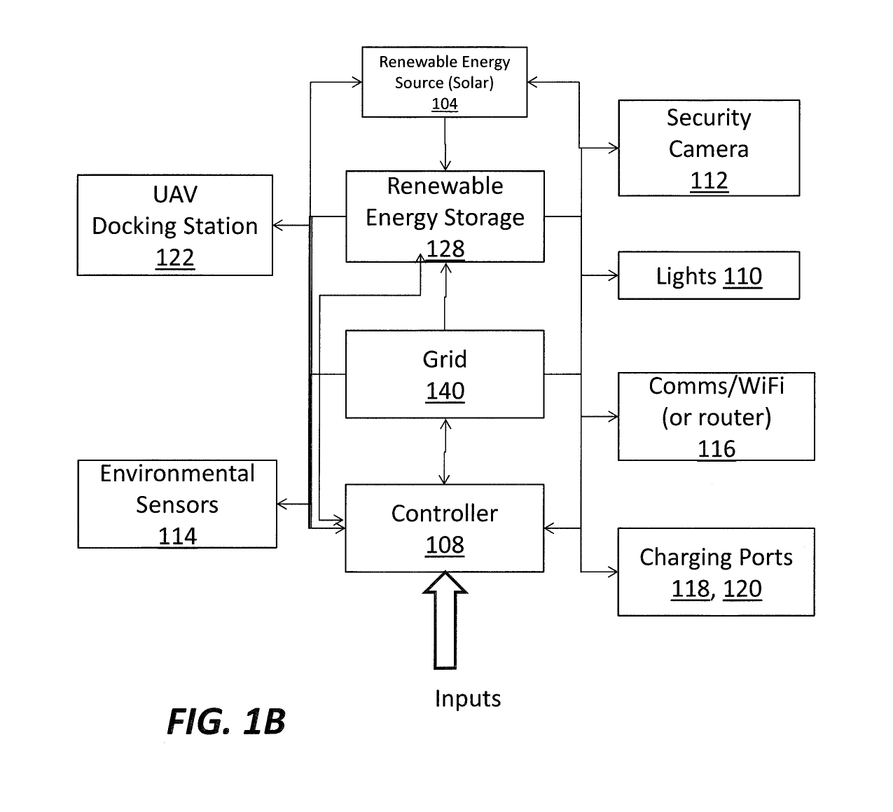

FIG. 1A is a cross-sectional diagram of a utility tower 100, according to an illustrative embodiment of the invention. The utility tower 100 includes a vertical structure, one or more lights 110a, 110b, and 110c, and a controller 108.

The vertical structure can include a utility pole 102 and a canopy structure, which can be a single form or include one or more canopy portions 106. In various embodiments, the number of canopy portions is 5. In some embodiments, the size of each canopy portions 106 is based on a size to accommodate one or more renewable energy sources (e.g., solar cells). In some embodiments, the canopy area ranges from 10 square feet to 300 square feet.

The utility pole 102 can include an energy storage 128, a converter 126, an electric vehicle charging port 118, a universal serial bus charging port 120, and/or the controller 108. In some embodiments, the utility tower 100 includes an inductive charger (not shown). In some embodiments, the utility pole 102 includes a connection port that can connect the utility tower 100 to the grid (e.g., an electric power line grid as described above). In some embodiments, the utility pole 102 includes a touch screen interface for a user (e.g., to request power from the utility pole and/or to interact with and/or transact with the utility pole capabilities).

In some embodiments, the utility tower 100 includes multiple charging ports. In various embodiments, the charging ports are AC and/or DC outlets. In some embodiments, the utility pole 102 includes a smart phone charging port (e.g., an iPhone charging port and/or an Android charging port). In various embodiments, the utility pole 102 includes an electric bicycle charging port, a scooter charging port, a motorcycle charging port, and/or charging ports for medical equipment aboard an ambulance. In some embodiments, the utility tower 100 includes an electronic vehicle charging cord (e.g., a spring-loaded cord that allows the electronic vehicle cord to extend from and retract into the utility tower 100). As is apparent to one of ordinary skill in the art, the utility tower 100 can include charging ports as are known in the art to charge various electronic devices.

In some embodiments, the utility tower 100 includes wireless charging (e.g., wireless inductive charging). The wireless charging can be at ground level and/or at a level above ground sufficient for an unmanned aerial vehicle to land on.

In some embodiments, the energy storage 128 is a rechargeable battery. In various embodiments, the energy storage is a fusion cell, a flow battery, a flywheel, and/or a simple pulley that lifts weight up the utility tower 100 and stores the energy as potential energy. In various embodiments, the energy storage 128 stores between 40 to 200 kilowatts/hours of power. In various embodiments, the energy storage 120 stores an amount of power that depends on anticipated loads of the utility tower 100. In various embodiments, the energy storage 120 stores an amount of power that substantially exceeds the loads of the utility tower to accommodate storage of energy generation external to the tower. In some embodiments, the energy storage 128 is addressable over a telecommunications network (wireless or wireline) and can be controlled via a remote controller (e.g., via the telecommunications network).

In various embodiments, the converter 126 is an inverter, regulator, transformer or rectifier. In some embodiments, an AC to DC converter or a DC to AC converter. For example, for an energy storage 128 of a rechargeable battery, an AC to DC converter can convert energy received from the grid such that it can be stored in the rechargeable battery. In some embodiments, the converter 126 includes multiple converters. For example, in addition to the example AC to DC converter as described, a DC to AC converter can be used to convert energy in a rechargeable battery to be provided to the grid. In some embodiments, the converter 125 is a DC to DC converter or an AC to AC converter to, for example, directly deliver power form an electric battery to another device requiring DC voltage, or transform AC power to various AC voltages, respectively.

In various embodiments, the converter 126 is a solar inverter that can include functions for use with a photovoltaic array, e.g., maximum power point tracking and/or anti-islanding protection. In these embodiments, the solar inverter can be any combination of the following:
Stand-alone inverters that can be used in isolated systems where, for example, the inverter draws its DC energy from the energy storage 128 which can be charged by a renewable energy source. Many stand-alone inverters can also incorporate battery chargers to, for example, replenish energy storage 128 from an AC source, when available;
Grid-tie inverters that can match the phase of its solar-generated AC power with the grid-supplied sine wave. The grid-tie inverters can shut down automatically upon loss of utility supply, for safety reasons; and/or
Battery backup inverters that can draw energy from a battery, manage the battery charge via an onboard charger, and/or export excess energy to the grid when requested or calculated to do so. The battery backup inverters can supply AC energy to selected loads during a utility outage, and can be require to have anti-islanding protection.

The one or more canopy portions 106 can include an unmanned vehicle docking station 122, one or more renewable energy sources (e.g., one or more solar cells 104), a WiFi hub (or router) 116, a security camera 112, and/or one or more environmental sensors 114.

In some embodiments, the one or more solar cells 104 are a photovoltaic (PV) cell array having at least one photovoltaic cell. In various embodiments, the PV cells can provide between approximately 0.5 kilowatts to 20.0 kilowatts of electrical power. The one or more solar cells 104 can be any solar cell as is known in the art.

In various embodiments, one or more solar cells 104 can be replaced with other types of renewable energy sources. For example, the renewable energy sources can be a wind source (e.g., wind turbines), kinetic capture, geothermal, fuel cell, and/or fossil fueled-based generator. In various embodiments where there are more than one renewable energy sources included with the utility tower 100, the plurality of renewable energy sources can be any combination of renewable energy sources. In some embodiments, the one or more canopy portions 106 can be oriented to maximize energy capture dependent upon the type of renewable energy source. In some embodiments, a concave lens is coupled to a surface of the canopy to allow for directed solar energy.

In some embodiments, a motor (not shown) is coupled to the one or more canopy portions 106 to rotate, tile and/or orient the one or more canopy portions 106. For example, the one or more canopy portions 106 can be oriented such that one or more solar cells disposed thereon can be in a position to maximize solar energy incident on the one or more solar cells.

In some embodiments, the unmanned vehicle docking station 122 can include a charging station for an unmanned vehicle 124. In various embodiments, the WiFi hub 116 can connect to networks via wired and/or wireless connections. In various embodiments, the utility tower 100 includes long-haul wireless, cellular network routers and antennas and/or satellite dishes. In some embodiments, the utility tower 100 includes beacons, such as flashing blue lights or Bluetooth beacons, or other devices for indicating tower location and/or providing location-finding services. In some embodiments the utility tower 100 includes one or more speakers to, for example, play announcements, music, news and/or other transmissions. In some embodiments, speakers can be used with on-board microphones to, for example, allow for two-way communications and/or interfaces.

In some embodiments, the lighting 110 is positioned such that the utility tower 100 functions as a street light (e.g., on the bottom of the canopy portions petals emitting towards base of the utility tower 100).

In various embodiments, the security camera 112 is remotely controlled, controlled by the controller 108, or any combination thereof. The security camera 112 can be positioned at any location on the utility tower.

The environmental sensors 114 can be positioned inside and/or outside of the canopy portions (as shown in FIG. 1), inside and/or outside of the utility pole 120, and/or at any location on the utility tower 100. The environmental sensors 114 can be audio, microphone and/or other listening devices to record sounds nearby. The environmental sensors 114 can measure weather, air quality, pollutants, presence of hazardous chemicals, germs and/or radiation. The environmental sensors 114 can capture local traffic information and/or include below-ground sensors for capturing information such as seismic signals, monitoring soil, and/or water contaminants. In various embodiments, the utility tower 100 includes adjacent and/or nearby parking space status monitoring sensors and/or seismic monitoring sensors. In some embodiments, the environmental sensors 114 and/or any other sensors deployed on the utility tower 100 can be addressable via secure local panel access and/or secure PKI-based network access.

In some embodiments, the utility tower 100 includes one or more coils (not shown) that can dispel excess heat and/or melt accumulated snow and ice, for example to prevent access obstruction and/or icicle formation.

In various embodiments, the utility tower 100 has a height between 18 and 45 feet tall. In some embodiments, the utility tower 100 has a height that is in accordance with particular country and/or municipality standards (e.g., approximately 40 feet above ground and six feet below ground). In some embodiments, the utility tower 100 is between 18 and 120 feet tall.

In various embodiments, the utility tower 100 includes a traffic light and/or signs such that the utility tower 100 can serve as a traffic control device. In some embodiments, the utility tower 100 includes a display (e.g., a touch screen display). The display can provide messages, emergency broad case alerts, amber alerts, news, advertisements, and/or other information. The display can allow a user to enter a request for power, user account information, a user to remotely control household devices (e.g., video cameras or air conditioners) and/or allow the user to initiate an audio and/or video call to another third party. In some embodiments, the utility tower 100 can include voice activation.

In some embodiments, there is a protocol for achieving interactions between the utility tower 100 and a load requesting power (e.g., identification, authentication, confirmation and/or payment).

In some embodiments, the utility tower 100 includes a vending machine. In some embodiments, the utility tower 100 includes an automatic teller machine (ATM). In other embodiments, the utility tower 100 can allow pedestrians to interact with the tower using a kiosk, display, or touchscreen with gesture inputs. In various embodiments, the utility tower 100 can collect rain water, melted snow, moisture in the air circulating within the utility tower 100 and/or ground water to purify and/or store water. In some embodiments, the utility tower 100 can provide tickets for parking cars.

FIG. 1B is a block diagram illustrating communication between components of the utility tower 100 of FIG. 1A, according to an illustrative embodiment of the invention. The controller 108 is coupled to each component in the utility tower 100 to receive data and/or transmit data to each of the components in the utility tower. As is apparent to one of ordinary skill in the art, the controller can be one computer device or can be implemented over multiple computing devices within the utility tower 100. Power sensors and actuators are installed on the renewable energy source (solar) 104, renewable energy storage 128, grid 140, UAV docking station 122, environmental sensors 114, security camera 112, lights 110, Comms/WiFi (or router), 116, charging ports 118, 120, and controller 108.

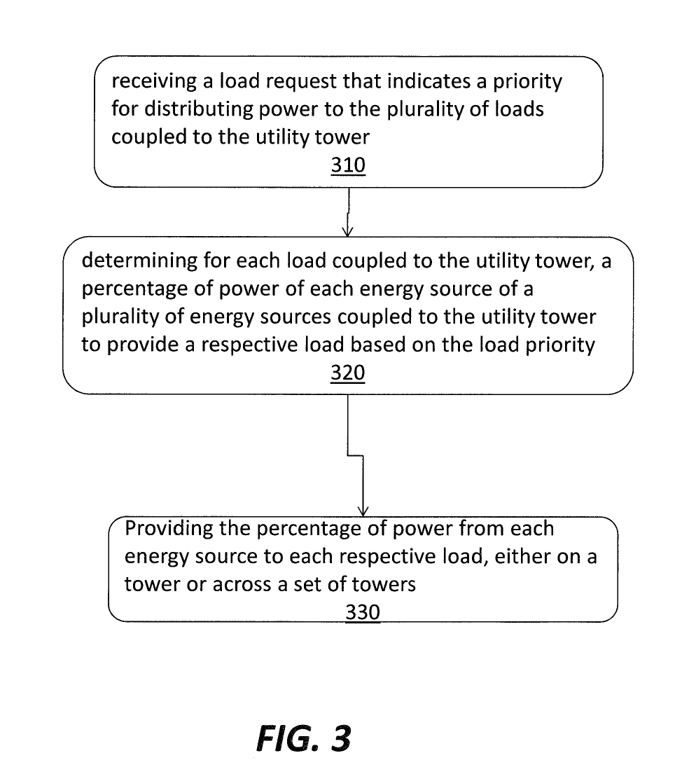

The controller 108 can monitor the grid 140, and based on the monitored parameters the controller 108 can allow the grid 140 to provide a predetermined amount of power to any of the components within the utility tower 100. The controller 108 can also allow the grid to receive energy from the utility tower 100, e.g., as per the energy balance calculations along with the inputs and/or constraints, as described below in connection with FIG. 3.

The energy storage 128 can communicate with the controller 108, and based on inputs from the controller, the energy storage 128 can provide a predetermined amount of power any of the components within the utility tower 100 and/or receive power from the solar cell 104 and/or the grid 140. The controller 108 can determine which power source to use (e.g., grid 140, solar 104, or energy storage 128) and/or an amount of power (e.g., percentage form each source) to provide to loads (e.g., devices coupled to the charging ports, the utility tower 100 components that require power, or any combination thereof) based on user inputs, one or more inputs form the utility tower components, or any combination thereof.

In some embodiments, the utility tower 100 can broadcast availability of charging spots to nearby vehicles and/or Internet applications (e.g., Google Maps). In some embodiments, the utility tower 100 has a shut down and/or emergency mode. The shutdown mode can shut the utility tower 100 down completely, and the emergency mode can be a configurable mode.

The controller 108 can operate as is described in further detail below, in the description of FIG. 3.

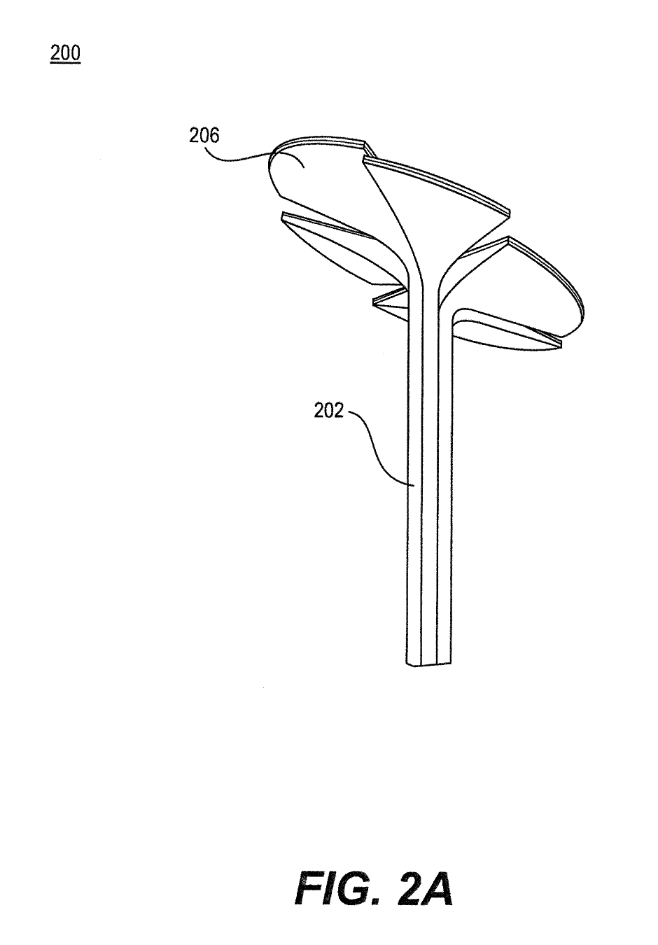

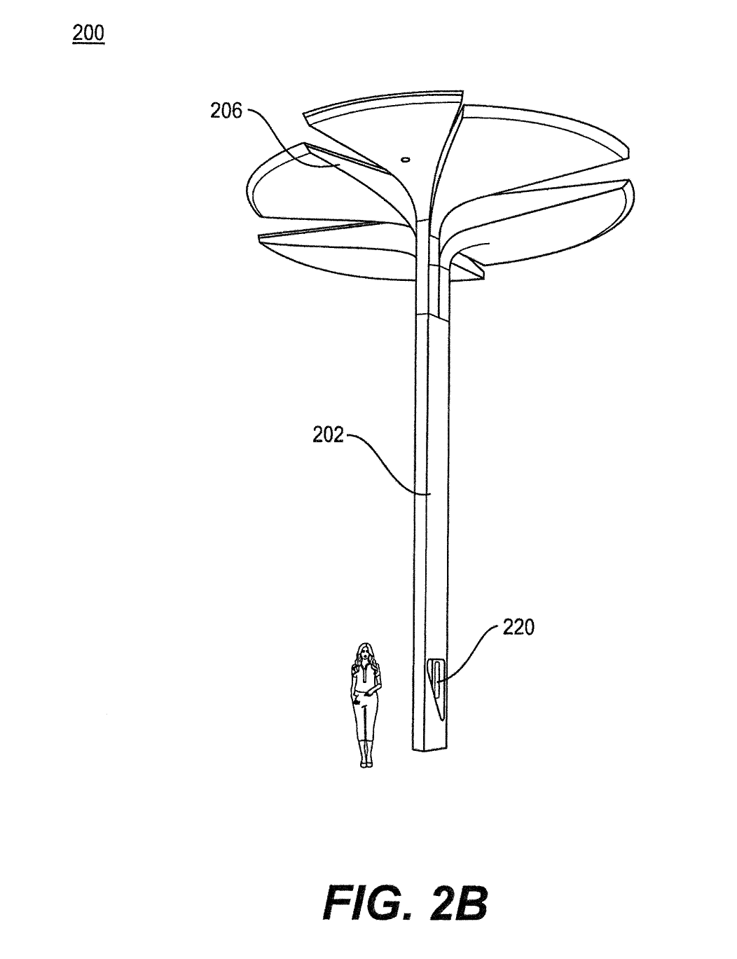

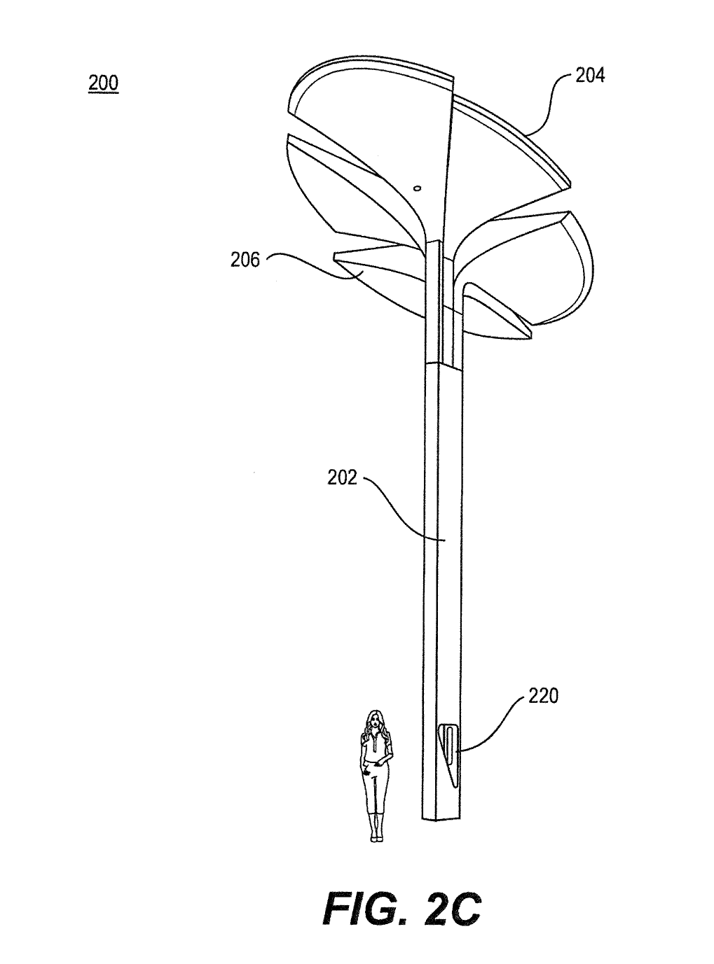

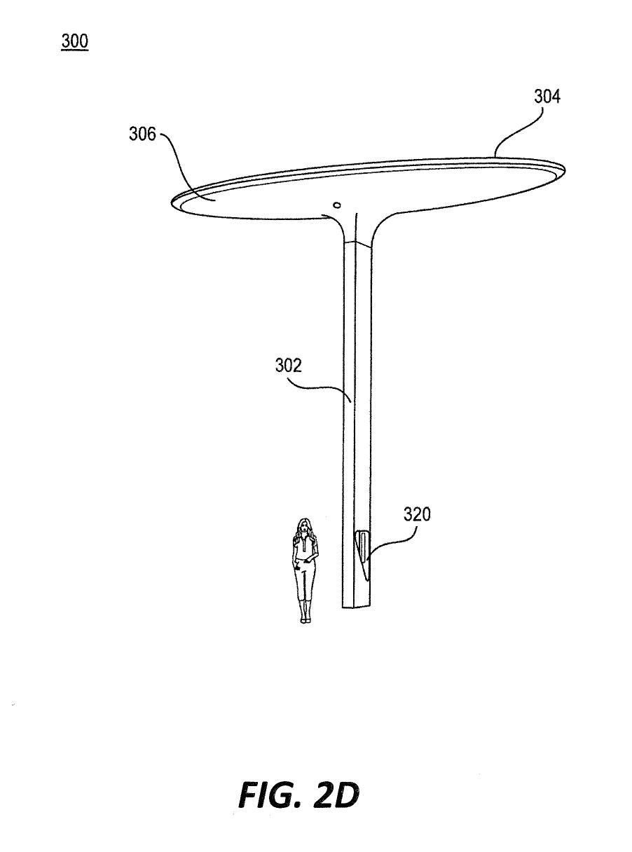

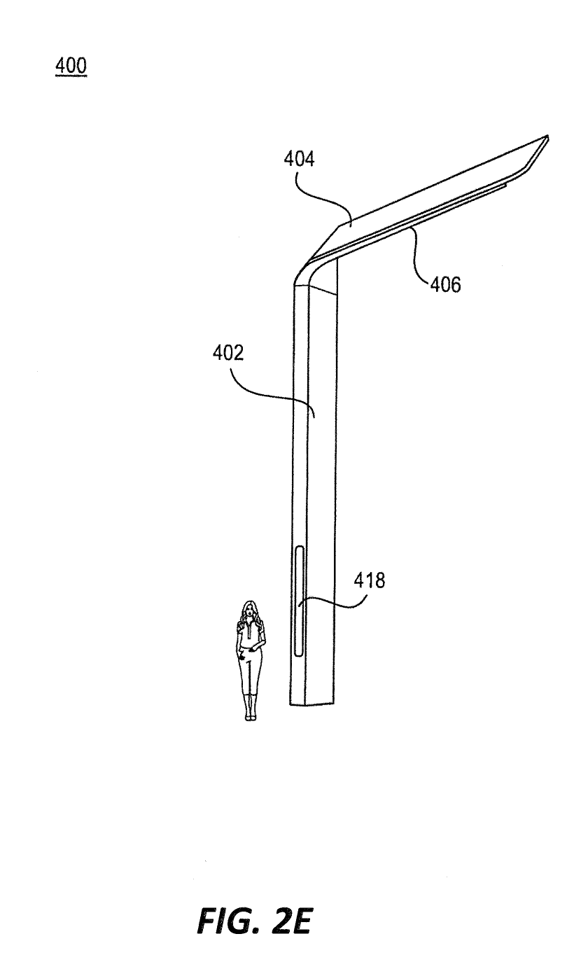

FIGS. 2A-2E are diagrams of various utility towers with canopies of various physical shapes having various portions in various configurations, according to illustrative embodiments of the invention. FIGS. 2A-2C illustrate utility towers 200 with different portions 206 configurations/orientations. As shown, portions 206 and solar cells 204 can be oriented at different angles with respect to the pole, a ground surface and/or the sun.

FIG. 2D shows an embodiment of a utility tower 300 with a substantially oval shaped canopy 306 and a charging port 320. FIG. 2E shows an embodiment of a utility tower 400 with canopy 406 having a single portion. The canopy 406 can be covered with solar cells 404.

FIG. 3 is a flow chart of a method for energy generation, management and/or distribution for a utility tower (e.g., the utility tower 100, as described above with respect to FIG. 1) having a plurality of energy sources (e.g., the renewable energy sources 104 and the grid 140, as described above in FIG. 1) and a plurality of loads, according to an illustrative embodiment of the invention. Some of these loads may also serve as an energy source, when not serving as a load; for example, an electric battery. The plurality of energy sources and of loads may span contiguous physical distances, be interconnected via a set of instances of this utility tower 100 with direct wiring or connected via the electrical distribution or transmission network. They may be grouped by physical adjacency or virtually in an arbitrarily defined set.

The method can involve receiving a load priority that indicates a priority for distributing power to the plurality of loads coupled to the utility tower. Such loads may be internal to the utility tower or external to the utility tower and the plurality of loads can include at least two of: a device coupled to a charging port of the utility tower (e.g., the EV charging port 118, as described above in FIG. 1), an energy storage of the utility tower (e.g., the energy storage 128, as described above in FIG. 1), a light (e.g., the light 110, as described above in FIG. 1), a controller (e.g., the controller 108, as described above in FIG. 1) (Step 310), communications equipment (e.g., WiFi hub, or cellular connection) or one or more other utility towers.

In various embodiments, the plurality of energy sources includes the energy storage of the utility tower, a renewable energy source coupled to the utility tower, an electric grid coupled to the utility tower, or any combination thereof.

In some embodiments, the load priority is input by a user. In some embodiments, the load priority is based on a subscriber status of the load, energy requirement of the load, a number of loads coupled to the utility tower, or any combination thereof. In some embodiments, the load priority is determined each time a load requests power. In some embodiments, the load priority can be defaulted to prioritize power deliver to firstly, internal loads of the utility tower, secondly, local external loads of the utility tower and thirdly, the grid and other instances of this utility tower.

The method can involve determining, for each load coupled to the utility tower, a percentage of power of each energy source of the plurality of energy sources coupled to the utility tower to provide to a respective load based on the load priority (Step 320).

Determining a percentage of power of each energy source of the plurality of energy sources coupled to the utility tower to provide to a respective load based on the load priority, can include determining an amount of available power at the utility tower. The amount of available power at the utility tower can be based on whether each element of the utility power can sink or source power, including a grid connection, if configured to exist. Whether each element of the utility power can sink or source power can be based determining one or more power distribution criterion. For example, as follows:
(i) Demand for power (e.g., load demand) based on number of loads coupled to the utility tower and number of loads requesting power from the utility tower;
(ii) Amount of power available from renewable energy sources of the utility tower. For utility towers that include at least one solar cell, the amount of power available can include an assessment of current and predicted weather to assess the availability of power from the at least one solar cell;
(iii) Amount of power available from the grid coupled to the utility tower;
(iv) Time of day usage;
(v) Regional utility supply capacity/availability;
(vi) Regional and national utility supply market pricing;
(vii) Current and predicted weather at the utility tower;
(viii) Real-time and/or scheduled emergency response demand;
(ix) Power demand based upon regulation and/or statutes (e.g., U.S. federal, state and/or local regulation);
(x) Power quality
(xi) News and/or social media feeds to, for example, predict demand.

Each of the quantities in items (i) through (xi) can be determined based on current values, historical values, predictive algorithms (e.g., machine and/or deep learning), or any combination thereof.

In some embodiments, the power available for a given load (L₁) on any given utility tower can be determined as shown below in EQN. 1:

Lᵢ=(G·X_{G(i)}·S_{G(i)}+B·X_{B(i)}·S_{B(i)}+P·X_{P(i)}·S_{P(i)}) EQN. 1a

L=Σᵢ₌₀ⁿLᵢ where n is the number of loads on a utility tower EQN. 1b

where G is the total power drawn from the grid on a utility tower, L is the total power demand from the loads on the utility tower, B is the total power drawn from storage on the tower, P is the total power supplied by the renewable energy source on the tower (e.g., solar), S_{G} is a control structure and used to set whether to use the grid power as a source (e.g., values of 0 or 1), X_{G} is a percentage of the available grid power to use for Lᵢ (e.g., values between 0 and 1), S_{B} is a control structure and used to set whether to use one or more energy storages (e.g., battery) as a source (e.g., values of 0 or 1), X_{B} is the percentage of the available energy storage power to use (e.g., values between 0 and 1), S_{P} is a control structure and used to set whether to use one or more renewable energy sources (e.g., solar cell) as a source (e.g., values of 0 or 1), X_{P} is the percentage of the available renewable energy power to use (e.g., values between 0 and 1).

The values for each of the terms in EQN. 1a can be based on the assessments made in items (i) through (xi) as described above. For example, in determining S_{P} (a control structure), whether or not to use the one or more renewable energy sources, the assessment of weather, item (vii) as described above, can indicate whether the particular renewable energy source is likely to provide sufficient power. For example, for a renewable energy source of a wind turbine, wind speed can be assessed.

In some embodiments, the total power supplied to or drawn from the grid (G) can be determined as shown below in EQN. 2:

$$G = \frac{L \cdot {X}_{L} \cdot {S}_{L} + B ( {X}_{{B}_{L}} \cdot {S}_{{B}_{L}} - {X}_{{B}_{S}} \cdot {\overline{S}}_{{B}_{L}} ) - P ( {X}_{P} \cdot {S}_{P} )}{{X}_{{G}_{S}} \cdot {\overline{S}}_{{G}_{L}} - {X}_{{G}_{L}} \cdot {S}_{{G}_{L}}} \qquad EQN . 2$$

where L is the total power demand from the load(s), B is the total power drawn from storage, P is the total power supplied by the renewable energy source (e.g., solar), S_{L} is a control structure and used to set whether to deliver power to the load (e.g., values of 0 or 1), X_{L} is percentage of power to deliver to the load (e.g., values between 0 and 1), B is magnitude of one or more available energy storage power, S_{B}_{_{L}} is a control structure and used to set whether to use the one or more energy storages as a load or sink, X_{B}_{_{L}} is percentage of the one or more energy storages to load or sink, S̅_{B}_{_{L}} is a control structure and used to set whether to use the one or more energy storages as a source, X_{B}_{_{S}} is percentage of the one or more energy storages to sink or load, P is magnitude of one or more available renewable energy sources, X_{P} is a percentage of power from the one or more renewable energy sources, S_{P} is a control structure and used to set whether to use the one or more renewable energy sources as a source, S̅_{G}_{_{L}} is a control structure and used to set whether to use the grid as a source, X_{G}_{_{S}} is percentage of power from the grid to use a source, S_{G}_{_{L}} is a control structure and used to set whether to use the grid as a sink or load, and X_{G}_{_{L}} is percentage of the grid to sink or load. S̅_{G}_{_{L}} and S_{G}_{_{L}} are logical complements. The values for each of the terms in EQN. 2 can be based on the assessments made in items (i) through (xi) as described above. For example, in determining S̅_{G}_{_{L}}, whether or not to use the grid as a source, the assessment of time of day usage, item (iv) as described above, can indicate whether the grid is likely to have sufficient power given the time of day.

In some embodiments, the power available for a given load from the one or more energy storage units can be determined as shown below in EQN. 3:

$$B = \frac{L \cdot {X}_{L} \cdot {S}_{L} + G ( {X}_{{G}_{L}} \cdot {S}_{{G}_{L}} - {X}_{{G}_{S}} \cdot {\overline{S}}_{{G}_{L}} ) - P ( {X}_{P} \cdot {S}_{P} )}{{X}_{{B}_{S}} \cdot {\overline{S}}_{{B}_{L}} - {X}_{{B}_{L}} \cdot {S}_{{B}_{L}}} \qquad EQN . 3$$

where S_{L} is a control structure and used to set whether to deliver power to the load (e.g., values of 0 or 1), X_{L} is percentage of power to deliver to the load (e.g., values between 0 and 1), G is magnitude of the grid power, S_{B}_{_{L}} is a control structure and used to set whether to use the one or more energy storages as a load or sink, X_{B}_{_{L}} is percentage of the grid to load or sink, S̅_{B}_{_{L}} is a control structure and used to set whether to use the one or more energy storages as a source, X_{B}_{_{S}} is percentage of power from the one or more energy storages to sink or load, P is magnitude of one or more available renewable energy sources, X_{P} is a percentage of power from the one or more renewable energy sources, Sp is a control structure and used to set whether to use the one or more renewable energy sources as a source, S̅_{G}_{_{L}} is a control structure and used to set whether to use the grid as a source, X_{G}_{_{S}} is percentage of power from the grid to use a source, S_{G}_{_{L}} is a control structure and used to set whether to use the grid as a sink or load, and X_{G}_{_{L}} is percentage of the grid to sink or load.), S̅_{G}_{_{L}} and S_{G}_{_{L}} are logical complements, and so are, S̅_{B}_{_{L}} and S_{B}_{_{L}}. The values for each of the terms in EQN. 3 can be based on the assessments made in items (i) through (x) as described above. For example, in determining S_{B}_{_{L}}, a control structure, whether or not to use the one or more energy storages as a source, the assessment of real-time and/or scheduled emergency response demand, item (viii) as described above, can indicate whether the one or more energy storage units is likely to have sufficient power if power is provided to emergency response services.

The determinations in items (i) through (x) can be made every time a load requests power from the utility tower, at a predetermined period, or any combination thereof. The predetermined period can be based on a time it takes to complete the determinations of items (i) through (x).

In some embodiments, a network of utility towers (e.g., the utility tower 100, as described above in FIG. 1) communicates with a central controller. The central controller, operated, for example, as cloud server software or as a group of peer controllers meshed across a set of instances of the utility tower 100 (swarm intelligence), can consider the entire network of utility towers as if it were one utility tower, and determine an amount of power the network can supply to respective loads. The central controller can determine the amount of power the network can supply to the respective loads based on determining items (i) through (xi) and assessing EQNs. 1 through 3 as described above.

In some embodiments, inputs for each respective control variable are transmitted from each utility tower in the network to the central controller, and averaged for use in (i) through (xi) and assessing EQNs. 1 through 3 as described above to determine power demand for the network of utility towers. The central controller can also determine power demand for each utility tower in the network. The determinations made by the central controller can be transmitted to each utility tower in the network. The controller can determine which utility towers and respective sources can provide power and which sinks are prioritized to receive power.

Once each Totem understands the instantaneous power demand of its respective loads and that are on the same electric circuit or within logical or physical proximity or connected to the same electrical distribution network, (a) the energy balance equations are satisfied for each individual utility tower 100 and for the logical set of instances of the utility tower 100, (b) communicated to each utility tower 100 in the set, and (c) the controls activated for which sources are enabled to provide power to which sinks are prioritized to receive the said power, including those sources which require replenishment or recharging, e.g., electric batteries.

In some embodiments, the network of utility towers is created by deployment of an arbitrary number of utility towers at physical locations (e.g., to provide power a particular set of buildings, over physical distances). Each utility tower 100 in the network can perform local inventories and/or report to other instances of the utility tower 100 within the network the registered, configured loads it has directly connected. For example, EV charging system, IoT sensors/actuators, communications equipment, and/or municipal street lighting.

The set of instances of utility tower 100 in the network can be connected together electrically via a grid connection, e.g., on an electrical power network behind a physical property's meter, and each utility tower 100 in the network can be connected to each other utility tower 100 in the network via a communications network either wirelessly (e.g., WiFi and/or cellular) or wired (e.g., fiber, Ethernet, coaxial cable, and/or modems directly on the grid).

In some embodiments, external loads that are connected to the properties electrical wiring are also configured for existence and/or power rating. In some embodiments, the utility tower's remote sensing units are installed alongside each load that is on the property electrical circuit. These sensing units can report the power usage on a regular interval to the utility towers on-property or the cloud server.

In some embodiments, where there is a network of utility towers, if the controller goes down, each of the utility towers can communicate directly with one another.

The method can involve providing the percentage of power from each energy source to each respective load (Step 330).

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes. Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

1. A utility tower for energy generation, management and distribution, the utility tower comprising:
a vertical structure comprising:
at least one energy storage, and
at least one communication network to communicate power requirements, power quality, power available or any combination thereof;
at least one power source coupled to the at least one energy storage,
at least one controller to calculate at least one power distribution criterion and to control the energy transfer from the at least one energy storage to one or more loads based on the at least one power distribution criterion.

2. The utility tower of claim 1 wherein the at least one power source is a renewable energy source or an electric grid.

3. The utility tower of claim 1 wherein the vertical structure further comprises a canopy.

4. The utility tower of claim 3 wherein the canopy comprises at least one renewable energy source that converts to electricity.

5. The utility tower of claim 4 wherein the converted electricity is supplied to the at least one energy storage.

6. The utility tower of claim 4 wherein the at least one renewable energy source is a photovoltaic cell array having at least one photovoltaic cell.

7. The utility tower of claim 1 wherein the at least one communication network is a wired or wireless network.

8. The utility tower of claim 1 further comprising at least one light coupled to the vertical structure.

9. The utility tower of claim 1 further comprising at least one charging port coupled to the vertical structure to allow a device to receive energy from the energy storage, an electric grid or both.

10. The utility tower of claim 1 further comprising at least one GPS sensor.

11. The utility tower of claim 1 wherein the at least one energy storage is a rechargeable battery.

12. The utility tower of claim 1 further comprising an unmanned aerial vehicle docking station coupled to the canopy such that an unmanned aerial vehicle can land upon the canopy.

13. The utility tower of claim 12 further comprising a wireless inductive charger coupled to the unmanned aerial vehicle docking station to charge the unmanned aerial vehicle.

14. The utility tower of claim 1 wherein the canopy is oriented at an angle with respect to the vertical structure to maximize the at least one solar cell's receipt of solar radiation.

15. The utility tower of claim 1 wherein the at least one charging port is an electric vehicle (EV) charging port and the vertical structure further comprises an EV cord management system.

16. The utility tower of claim 1 wherein the at least one charging port is a wireless inductive charger or a wired Universal Serial Bus (USB) connection.

17. The utility tower of claim 1 further comprising at least one router or WiFi hub coupled to the canopy.

18. A method for energy generation, management and distribution for a utility tower comprising a plurality of energy sources and a plurality of loads, the method comprising:
receiving a load priority that indicates a priority for distributing power to the plurality of loads coupled to the utility tower, wherein the plurality of loads comprises at least two of a device coupled to a charging port of the utility tower, an energy storage of the utility tower, a light, and a controller;
determining, for each load coupled to the utility tower, a percentage of power of each energy source of the plurality of energy sources coupled to the utility tower to provide to a respective load based on the load priority; and
providing the percentage of power from each energy source to each respective load.

19. The method of claim 18 wherein the plurality of energy sources comprises the energy storage of the utility tower, a renewable energy source coupled to the utility tower, an electric grid coupled to the utility tower, or any combination thereof.

20. The method of claim 18 wherein determining a percentage of power is further based on a first amount of power available from the renewable energy source, a second amount of power available from the energy storage, a third amount of power available from an electric grid coupled to the utility tower, time of day, historical time of day usage, a cost of power, weather conditions, regulatory statutes, emergency service reserved power or any combination thereof.
